(19) United States
(12) Patent Application Publication
(10) Pub. No.: US 2020/0193486 A1
(43) Pub. Date: Jun. 18, 2020

(54) SYSTEM AND METHOD FOR DETERMINING BID VECTOR TRANSFORMED PREDICTIVE CLICK-THROUGH RATE

(71) Applicant: Motive Interactive, Inc., San Diego, CA (US)

(72) Inventors: Gokhan ORDEK, San Diego, CA (US); Roman NEKHOROSHEV, San Diego, CA (US); Tyler CORNELL, San Diego, CA (US)

(21) Appl. No.: 16/714,317

(22) Filed: Dec. 13, 2019

Related U.S. Application Data
(60) Provisional application No. 62/779,976, filed on Dec. 14, 2018.

(51) Int. Cl. G06Q 30/02; G06Q 30/08

(52) U.S. Cl. CPC G06Q 30/0275; G06Q 30/0242; G06Q 30/0201; G06Q 30/08

(57) ABSTRACT

Systems, methods, and computer-readable media for pricing an auction for an advertisement campaign in and real-time bidding environment are provided. The method can include receiving a bid request having a plurality of features and feature value and extracting stored values from the feature matrix corresponding to the feature values, and determining a bid vector based on the stored values and an ideal click vector based on best values for the features stored in the feature matrix. The method can include determining a similarity measure between the bid vector and the ideal click vector and calculating a probability click through rate (pCTR) index based on the similarity measure. The pCTR index can be used for selecting whether to not bid, maintain the bid, or increase the bid on certain advertising.

### CROSS-REFERENCE TO RELATED APPLICATIONS

This application claims priority to U.S. Provisional Application Ser. No. 62/779,976, filed Dec. 14, 2018, entitled, “SYSTEM AND METHOD FOR DETERMINING BID VECTOR TRANSFORMED PREDICTIVE CLICK-THROUGH RATE,” the contents of which are hereby incorporated by reference in their entirety.

### BACKGROUND

### Technical Field

The present disclosure relates to predictive modeling of media and online implementation in programmatic buying for Real-time bidding platform.

### Related Art

Online advertising has become one of the fastest growing industries in the recent years ($88 billion in revenue according to IAB 2017 report). While there are several media drivers factored in, mobile advertising accounted for the largest share (57%; 2017, and 51% in 2016) of all the digital advertising growth. The technology behind this growth is called Real-time-bidding (RTB), where advertisers trade ad inventory on a per-impression basis via a programmatic instantaneous auction through multiple ad-networks (can be referenced). While RTB has provided a high-scale market, it also opened up a key challenge for advertisers: To optimize buying strategies by utilizing millions of data points, automating bid prices to make bidding decisions in the millisecond range.

### SUMMARY

This disclosure addresses systems and methods for determining bid vector transformed predictive click-through rate.

An aspect of the disclosure provides a method for pricing an auction for an advertisement campaign in and real-time bidding environment. The method can include receiving, at one or more processors, a bid request having a plurality of features and feature values related to the plurality of features. The method can include comparing the plurality of feature values to a feature matrix stored in a memory coupled to the one or more processors. The method can include extracting stored values from the feature matrix corresponding to the plurality of feature values. The method can include determining a bid vector based on the stored values. The method can include determining an ideal click vector based on best values for the plurality of features stored in the feature matrix, the best values having a highest click probability for a given feature within the feature matrix. The method can include determining a similarity measure between the bid vector and the ideal click vector. The method can include calculating a probability click through rate (pCTR) index based on the similarity measure, the pCTR index comprising a probability between zero and one. The method can include selecting based on the pCTR index, to not bid, maintain the bid, or increase the bid. The selecting to not bid can be based on a first range of probability. The selecting to maintain the bid can be based on a first range of probability different than the first range. The selecting to increase the bid is based on a first range of probability different than the first range and the second range. The method can also include performing a test on a control line. The method can also include performing the test on a pCTR line. The method can also include measuring key performance indicators (KPIs) of the control line and the pCTR line based on the test of the control line and the pCTR line. The method can also include selecting one of the control line and the pCTR line for use in a campaign based on the KPIs.

Another aspect of the disclosure provides a system for pricing an auction for an advertisement campaign in and real-time bidding environment. The system can have a memory for storing a feature matrix having a plurality of features and feature values associated with each feature of the plurality of features. The system can have one or more processors communicatively coupled with the memory. The one or more processors can receive a bid request having a plurality of features and feature values related to the plurality of features. The one or more processors can compare the plurality of feature values to a feature matrix stored in the memory. The one or more processors can extract values from the feature matrix stored in the memory corresponding to the plurality of feature values. The one or more processors can determine a bid vector based on the stored values. The one or more processors can determine an ideal click vector based on best values for the plurality of features stored in the feature matrix, the best values having a highest click probability for a given feature within the feature matrix. The one or more processors can determine a similarity measure between the bid vector and the ideal click vector. The one or more processors can calculate a probability click through rate (pCTR) index based on the similarity measure, the pCTR index comprising a probability between zero and one. The one or more processors can select whether to not bid, to maintain the bid, or to increase the bid, based on the pCTR index.

Another aspect of the disclosure provides non-transitory computer readable media for storing instructions that when executed by one or more processors can perform the tasks of the method and the system described above.

Other features and advantages will be apparent to one or ordinary skill with a review of the following detailed description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 is a flowchart of an embodiment of a method for decision workflow of the pCTR in the campaign setup schema.

FIG. 2 is a graphical depiction of an embodiment of a system architecture for performing the method of FIG. 1;

FIG. 3 is flowchart of an embodiment of a method for validating a desired campaign via A/B test protocol;

FIG. 4 is a functional block diagram of an embodiment of a device for performing the methods of the disclosure; and

FIG. 5 is a flowchart of an embodiment of a method according to the disclosure.

### DETAILED DESCRIPTION

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

To address the challenges illustrated above, advertisers have to analyze ad performance via automated frameworks and estimate their arbitrage values for the next buying strategy. This is known as programmatic buying. One of the key indicators for the ad-performance, also known as key-performance indicators (KPIs), is click-through-rate (CTR), which measures the number of click(s) per the number of impression(s) that were paid for. Despite the fact that ‘clicks’ are not the direct profit for advertisers, it is the first step of the user engagement funnel and serves as a fundamental event to optimize. CTR is one of the most important metrics to measure and optimize ad performances for programmatic buyers in the RTB eco-system. While ‘conversions’, which are post-click user activities such as installs, membership, etc., are the main focus in mobile advertising, click(s) are the intermediate step that initiates the particular user events. Thus, prediction of clicks can play an important role in optimization of bid prices for advertisers, in order to maximize their return-on-investment (ROI). To this purpose, machine learning (ML) models provide powerful solutions to utilize large-scale historical data to predict click-through-rate (pCTR) with automated frameworks. This disclosure provides an automated pCTR framework to extract most significant features, cardinal data in bids, and implement a binary classification algorithm for the online bidding decision.

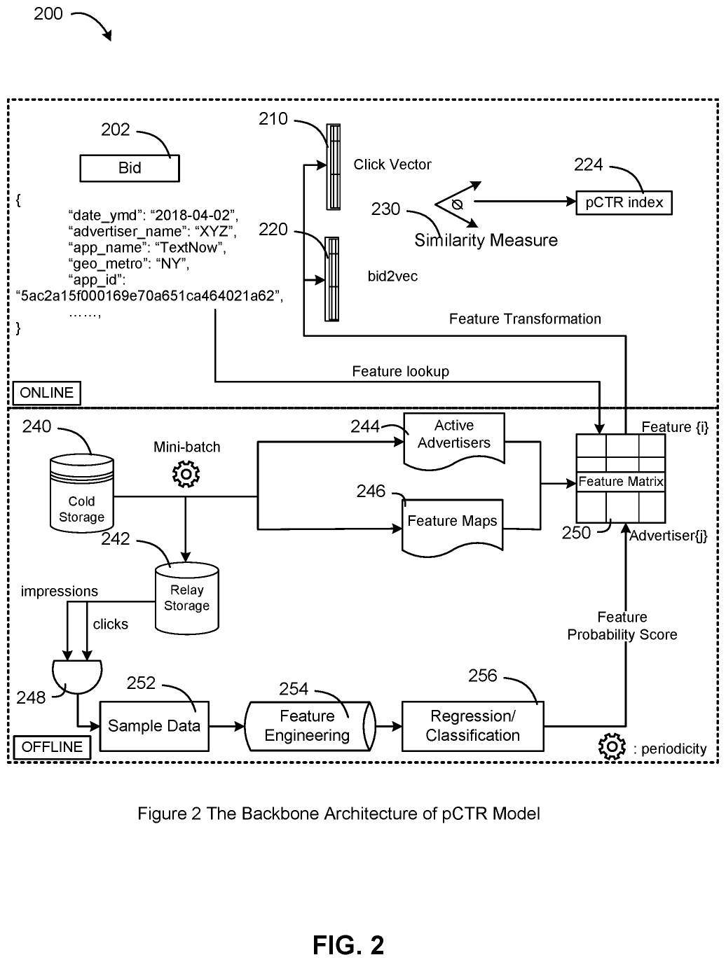

Estimation of clicks from impression data is described by a heuristic approach. Programmatic buying allows mobile advertisers to increase revenue from user actions (install, subscribe, purchase, etc.) from pay per impressions via RTB auction system. The disclosed system includes a semi-automated predictive CTR (pCTR) model for a high-scale online bidder system, which can train millions of data sets for each advertiser and extract the best predictive features to implement. The disclosed pCTR model implements a binary classification to estimate the probabilistic outcomes for selected features. “Features” as used herein, include desired elements of an advertisement or bid request. This can include, for example, date, advertiser name, application/app name, location, device type, etc. The features can also include the fields of the machine learning model described below in connection with FIG. 2.

In some embodiments, semi-autonomous options can allow media buyers and campaign managers to switch features on and off (e.g., select/deselect) features during their campaign duration. A buyer can dynamically enable/disable features per campaign as needed or desired. The features can be captured in feature matrices and maps and stored in a cache memory for a bidder to access within millisecond range to make decisions regarding a received bid. The bidder utilizes the feature matrix/matrices to transform a received bid request into to a vector, which is referred to herein as a bid2vector process. This produces a bid vector. Then, the bid vector can be compared with an ideal click vector for the similarity score. As used herein, an ideal click vector is the transformed ideal click matrix. The ideal click matrix is also captured in the cache memory for online retrieval. It can include feature values with the highest probabilistic scores, also interpreted as the ideal “clicker” an end-user would “click” in an online environment.

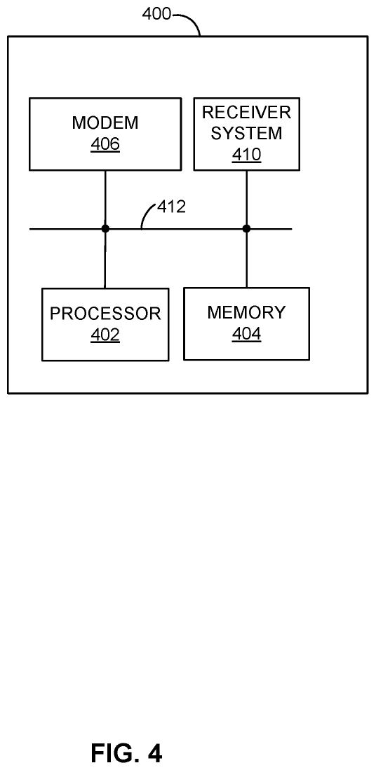

FIG. 4 is a functional block diagram of a computing device for implementing the methods described herein. A computing device (device) 400 can be implemented as small or large scale computing systems.

The device 400 can include one or more processors or processor units (processor) 402. The processor 402 can control operation of the device 400. The processor 402 can also be referred to herein as a central processing unit (CPU). The processor 402 can include or be a component of a processing system implemented with one or more processors 402. The one or more processors can be implemented with any combination of general-purpose microprocessors, microcontrollers, neural processing units (NPUs), on one or more application specific integrated circuits (ASICs), digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In some embodiments, the processors 402 can also perform quantum computing functions.

The device 400 can also have a memory 404 coupled to the processor 402. The memory 404 can include both read-only memory (ROM) and random access memory (RAM). The memory 404 can provide instructions and data to the processor 402. The memory 404 may store program codes, instructions, and data for the processor 402.

At least a portion of the memory 404 can also include non-volatile random access memory (NVRAM). The processor 402 can perform logical and arithmetic operations based on program instructions stored within the memory 404. The instructions in the memory 404 can be executable to implement the methods described herein. The processor 402 and the memory 404 can also include machine-readable media for storing software. Software shall be construed broadly to mean any type of instructions, whether referred to as software, firmware, middleware, microcode, hardware description language, machine learning (ML), artificial intelligence (AI), or otherwise. Instructions can include code (e.g., in source code format, binary code format, executable code format, or any other suitable format of code). The instructions, when executed by the one or more processors, cause the processing system to perform the various functions described herein. The memory 404 can further store training data and ML or AI databases enabling the processor 402 to make decisions in real time. The memory 404 can include one or more databases including the cold storage 240 and the relay storage 242 (FIG. 2).

The device 400 can also include modem 406 (modulate-demodulate). The modem 406 can perform tasks associated with communications (e.g., transmit and receive operations) via a wireless or wireline network. The modem 406 can be associated with a transmitter system and/or a receiver system to allow transmission and reception of data between the device 400 and a remote location. The modem 406 can enable the processor 402 to receive and transmit in various transmission protocols as needed for such wireless or wireline transmission.

The device 400 can have a user interface 410. The user interface 410 can be any device or peripheral component allowing a user to interact with or provide instructions to the processor 402, for example. The user interface 410 can include a pointing device, such as a mouse, touchscreen, or trackpad, a keyboard, microphone, speaker, etc. The user interface 410 can allow a user to, for example, select and deselect various features for testing and implementation according to the methods disclosed herein.

The various components of the device 400 can be coupled by a communications bus 412. The communications bus 412 can provide intercommunications within the device 400. The communications bus 412 can further provide communications for the device 400 as a whole to one or more networks, including a wide area network (WAN) such as the Internet, or a private network.

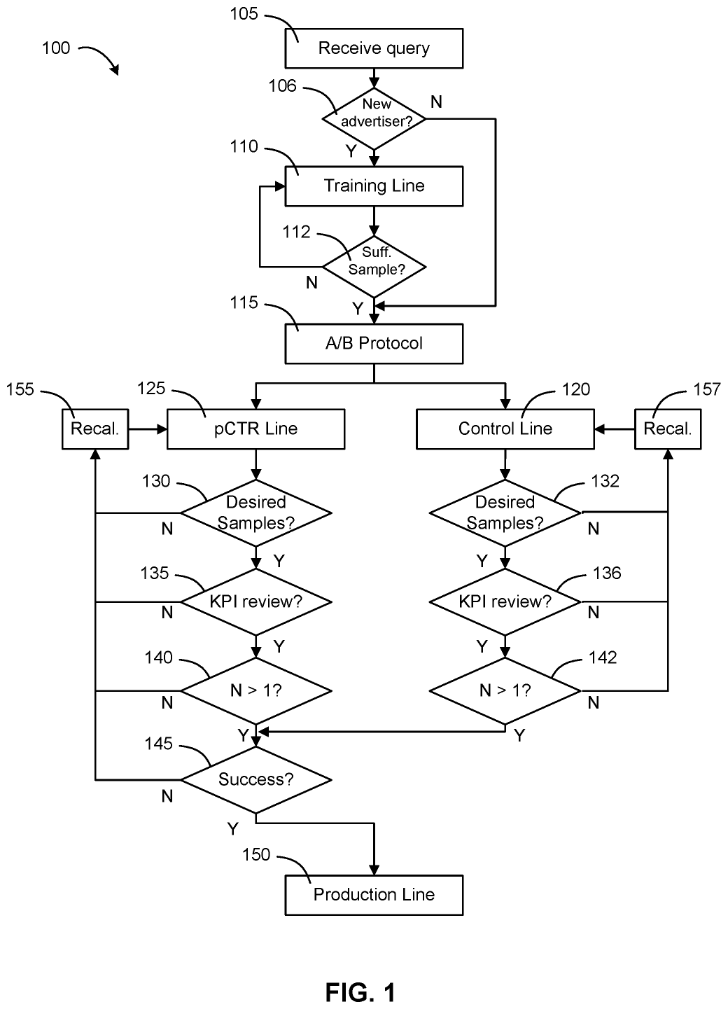

FIG. 1 is a flowchart of an embodiment of a method for pCTR setup. The flowchart of FIG. 1 depicts a method 100 for an exemplary ad campaign setup to test a line item. A line item targets defined criteria, as described above, with a configuration of how to buy, or price that targeted ad criteria, thus, known as the buying strategy. An ad campaign can embody a variable amount of line items. Thus, the ad campaign, or campaign, can act as a sort of bucket, containing the line items. In one example campaign for a company Acme, Inc., “ACME” might embody the following line items: “Acme production”, “Acme test”, “Acme control”. The campaign “ACME” could have an overall budget of $600, with each line item receiving $200 of that budget. In general, campaigns can be high-level configurations; line items can thus be low level configurations under or within a campaign. A line item will always belong to a campaign.

A line item, as used herein, refers to a strategy to target a set of user features, such as app bundle, geo location, device model, etc., for an advertiser. Each block labeled with the “line” label refers to such a line item. Each campaign can be monitored and operated by a campaign manager, who can test the pCTR on a line item. In one example, a line item can be set up to target, for example, only iPhones in the United States, and buy using the pCTR model, thus being the line item's buying strategy.

The method 100 can begin at block 105, in which the system receives insertion order (IO). If, at decision block 106, the IO is related to a new advertiser, the method 100 can include deriving an initial training data set at block 110. The initial training data set can be derived from the new advertiser's line item that will be performed. This is known as a cold start. A new advertiser can configure a training line item with broad targeting, designed to generate clean unbiased data used for training of the pCTR model. In this sense, a “training line”, refers to a line item with the purpose of generating data for training, so that new advertiser can utilize the model. This line item is set up with very broad targeting and a broad buying strategy.

At decision block 112, the processor 402 can determine whether the sample size is sufficiently large. Sufficient sample size (N) can be calculated over average CTR to meet statistical confidence level (p<0.05 or Cohen's d>0.8). If the training line item has generated a sufficient amount of data for the model to train, the A/B testing protocol can take place.

In general, the method 100, from blocks 105 to 112 can be referred to as a pre-cursor or cold start solution for incorporating a new advertiser into the process. For example, a new advertiser must have a training data set to be incorporated into the method 100. Therefore, the system needs to recognize that the required data threshold is not met, so a “training line item” needs to be generated to meet the sufficient sample size. Once that's met, the A/B testing can proceed. In contrast, existing users or accounts can bypass block 110 and decision block 112 using existing data.

For the existing advertisers that have a history of advertising, a training data set can be automatically derived from, a storage (e.g., cold storage, FIG. 2). This can be based on past history of advertising, for example. Thus feature matrices for said advertiser can be stored in memory for bid vector transformation without needing the cold-start solution.

Once the sample size ‘N’ is sufficient to begin for both the new/native advertiser, the method 100 can proceed to block 115.

In block 115, the processor 402 can perform an A/B test on two separate lines. The two separate lines can include 1) the test line, and 2) a control line. The two separate lines can consist of the same targeting criteria, with the test line containing one small adjustment, in this case, the buying strategy (pCTR). The process can further include testing each line independently.

The identically targeted line items belong to the same advertiser, the only difference between the two being the buying strategy itself. For example, the test line item can implement the pCTR model described, while the control line item runs a default buying strategy. The default buying strategy can serve as a control against which the pCTR model can be judged or evaluated. The default buying strategy used is the best performing buying strategy that currently exists in production for that line item. The two competing line items can target distinct sets of users that do not intersect. This can mean that campaign A will never see the same user as campaign B, and vice versa. This can be beneficial because guaranteeing line item A won't see the same users as line item B in this testing scenario is crucial for a well-controlled test. This is because users interact with ads differently at different frequencies. For example, it might take three impressions before a user eventually decides to click. This is crucial from a validation standpoint. If users intersect, it is possible the ad impression served from the control line item was already served to the same user in the test line item; therefore the test is no longer controlled.

The fundamental aspect of A/B test is to establish independent and random bid traffic between two lines (e.g., one test line and one control line) to measure the key performance indicators (KPIs) of each, for comparison. In addition to KPIs and sample size requirements, pCTR also requires at least two features to be present in the bid to qualify the test results.

At block 120, the processor 402 can create the control line item. In some examples, this can be the “A” in A/B split testing. The control line item A can be a replica of a “production” line item, but with a smaller test budget. A production line item, in general, is the line item (or collection of line items) that receives the majority of the campaign's budget. In one example, 90% of a budget can go to production, and 10% may go to testing (e.g., the A/B protocol of block 115). The control line (B) can be tested though the bidding process as it normally would be. The control line thus provides a basis for comparison for the test line (e.g., pCTR line) beginning with block 125.

At block 125, the processor 402 can create the test line item. In some embodiments, a user can influence the content or set up of a line item. In some examples, this can be the “B” in A/B split testing.

At decision block 130, the processor 402 can determine whether enough data has been collected to complete the test. For example, amount spent, impressions, clicks, and conversions can be included when making such a determination. This can vary depending on advertiser. The processor 402 can store various predefined thresholds and implement them when needed.

Assuming the test has achieved spending goals, the processor 402 can determine when sufficient data has been collected to end the test. If not, the method 100 can proceed to block 155 to recalibrate. Recalibration can include, for example, certain levels of intervention by the processor 402, in effort to adjust line items or targeting criteria. The A/B protocol for the control line can then start over.

If the test has sufficient data to complete, then at decision block 135, the processor 402 can review key performance indicators (KPIs). The processor 402 can determine whether the KPI or KPI's (e.g., click rate and conversion rate) for the test are greater than the same for the control line. If yes, then the processor 402 can validate feature counts. If no, then the method 100 can recalibrate the test at block 155.

If the test does not have sufficient data to complete at decision block 135, then the processor 402 can recalibrate at block 155. The method 100 can then return to block 120.

At decision block 140, the processor 402 can determine whether at least two features (N>1) have been selected and are being utilized. If no, the processor 402 can recalibrate the test at block 155. If yes, then at decision block 145, the processor 402 can confirm all success criteria within the line 130-140. That is, the processor 402 can determine whether A or B resulted in the best KPIs.

In a similar manner, decision block 132, decision block 136, and decision block 142 can include similar functions as the decision blocks 130, 135, 140 by the same name, performed on the control line. Block 157 can include a recalibration function similar to block 155.

At decision block 145, the processor 402 can validate the success criteria to determine which campaign performed best, A or B. If the test line did not outperform the control line, then the processor 402 can recalibrate test. Such an outcome indicates that the test was unsuccessful, and changes are required.

At block 150, a production line, which typically employs a higher budget, is duplicated from either pCTR or control line, whichever scores the superior KPIs. If the tested line item configuration has a higher success rate or scores superior KPIs, it can become a new production line item. The tested line item can then later become a control to test against in the future (given larger budget). If the control out performs the test, it can remain the production line item.

FIG. 2 is a functional block diagram of a system for performing the method of FIG. 1. A system 200 can be implemented to perform one or more of the processes and methods disclosed herein. FIG. 2 is a detailed overview of the pCTR architecture, as related to the buying strategy that the “test” line item uses in the A/B section of the method 100. The block diagram provides an architectural schema of pCTR model that included offline training process and online implementation.

Bottom Portion

The bottom portion of FIG. 2 is referred to as offline. In general, functions performed in the “offline” portion of FIG. 2 can include one or more time-consuming processes. As such, they are scheduled tasks and happen “offline.” Offline can be contrasted with “online” or real time processes. The output of such offline model training is what is brought online to the bidder, otherwise referred to as the produced model.

The offline portion can have a cold storage 240. The cold storage 240 can include a database where the offline system can retrieve large amounts of historical impression/click data to train the model. Cold storage 240 can retain event logs, campaign data (e.g., the features a media buyer selected on/off), etc.

The processor can interact with active advertisers 244 and feature maps 246 to select/deselect or enable/disable individual features from a respective matrix for testing and implementation in a campaign. This can provide the offline system an indication of what features should be included in the feature matrix for each advertiser.

The offline portion can also have a relay storage 242. The relay storage 242 can be act as an online, or “hot” storage for quicker data retrievals. This can be contrasted with the cold storage 240 that can include long term storage on file-systems. Relay storage 242 can be a more rapid access storage that can retain historical data after retrieval from the cold-storage 240.

The active advertisers 244 can receive input from the processor 402 in the way of selection or deselection of various features; these selections are stored in feature maps 246. This can influence the information that is stored in the feature matrix 250 for each advertiser. The impressions or clicks available in the relay storage 242 can then normalized and merged into sample data 252 before the processor 402 uses this sample data 252 for feature engineering 254.

At block 254 the processor 402 can extract features for training from the sample data 252 and transform to the appropriate data structure as input to the regression/classification algorithm 256.

The extracted features 254 can then processed using regression/classification 256, in which the output, or, probability scores are stored in the feature matrix. This feature matrix is eventually stored in memory for quick retrieval for online consumption.

Thus, the offline framework of FIG. 2 can be used (e.g., by the processor 402) to periodically engineer features from the relay storage 242 (impressions, clicks, etc.). As a probabilistic model, the method 200 can implement a logistic function with the ridge regression correction (e.g., block 256) (Shown in the implemented function section, below as equation (1)). The feature matrix 250 can be created for the set of feature coefficients that are trained for each active advertiser (Shown below in the implemented function section, below as equation (2)).

Top Portion

An incoming bid 202 (e.g., bid request) can be received at the processor 402. The text below the bid 202 in FIG. 2 includes a plurality of exemplary features (e.g., date_ymd, geo_metro, etc.) and feature values (e.g., 2018-04-02, NY, etc.). The incoming bid 202 as shown can be transformed into a bid vector, which denotes the bid requests features, and rated by the click vector, which denotes the ideal click features. This is referred to herein as a feature transformation. The feature transformations are extracted from the feature matrix, which must be trained and stored in the offline process. This is captured using the function of equation (3), below.

The system can then provide a similarity measurement 230. Conceptually, the similarity measurement 230 is measurement (e.g., a calculation) of the distance between two matrixes transformed into a vector. The closer the vectors align, the more similar they are, thus establishing a crucial relationship for predictions. If a bid vector is highly similar with our “ideal” click vector, the incoming bid request has a high probability of clicking. As a similarity measurement, cosine similarity is used to determine the strength of the relationship between bid and click vectors. Cosine similarity generates a Gaussian normalized distribution scores from 0 to 1 that corresponds to strong to poor similarity.

The similarity measurement 230 can then be converted to pCTR index from a logarithmic function (This is shown in the implemented function section, below as equation (4)) due to the nature of log-normal distribution of bid prices.

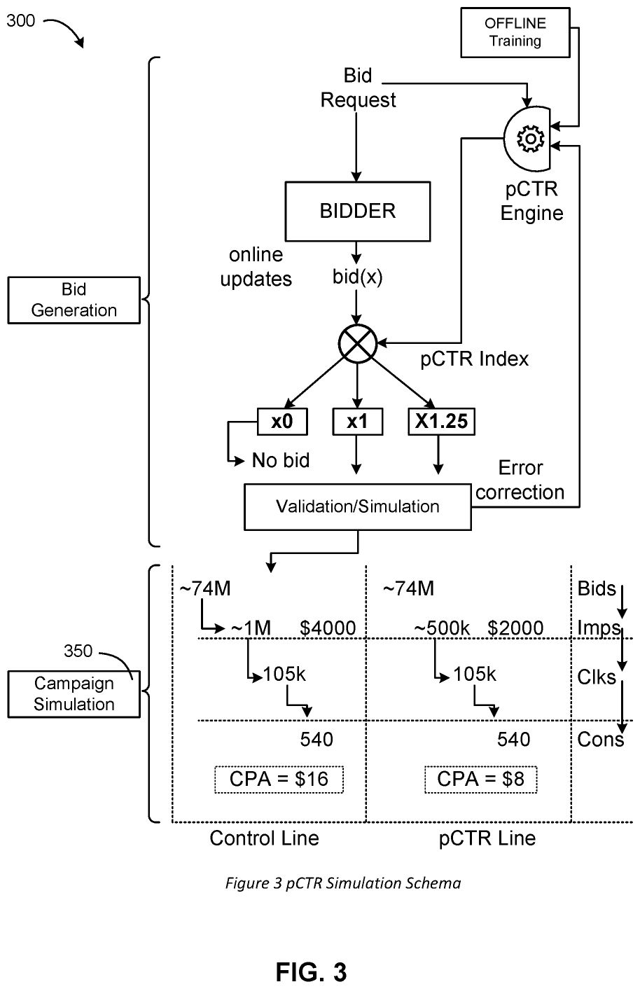

FIG. 3 is a flowchart of an embodiment of a method for online bidding using pCTR.

### Bid Generation:

As it is described in FIG. 2, the pCTR model extracts a score index (referred as pCTR index in FIG. 2.) for each bid request and updates the bidder for the final bid price. The bidder (e.g., a bid server that advertisers use to respond to (or reject) an incoming bid request) implements a simple transfer function to utilize pCTR index as a bid multiplier to adjust the base bid price (bid(x); average bid price of a same ad placement from the historical data. As an example, a step function can be used, which multiplies the base bid price by, for example, 0, 1, 1.25 with respect to low, medium or high pCTR index, respectively. These are exemplary values and are not limiting on the disclosure. Other values are possible.

### Campaign Simulation:

As shown in FIG. 3, a campaign simulation 350 process can be performed through mimicking the auction environment (RTB), which is based on the probability of the winning functions. The campaign simulation 350 can be similar to that described in connection with the method 100 (FIG. 1) including blocks 115 through 150. In one example, a day of bid requests can be split randomly and evenly across two lines: pCTR (e.g., test) and control, similar to the A/B test protocol described above. Simulation results suggest that the acquisitions of users in pCTR line (CPA=$8) is lower than control line (CPA=$16) from the same number of bids. Some of the critical assumptions are listed as, consistent win and conversion rates. Imps: Impressions; Clks: Clicks; Cons: Conversions. CPA refers to Cost per acquisition. This is a measure of how much money was spent before a user converted.

Equations are shown in the function sections below are used to calculate feature coefficients and pCTR index.

(I) Features are extracted and trained via logistic regression function. Each feature (app bundle, device model, etc.) is trained independently and allows campaign managers to switch on/off for a selected advertiser, campaign, or line item.

(II) Feature matrix denotes feature coefficients by the advertiser.

(III) Cosine similarity calculates the similarity between a desired bid and the click vectors.

(IV) Similarity index is translated into a logarithmic scale due to the nature of log-normal distribution of bid prices. To reverse upper and lower bounds, which cosine similarity ranges from 0 to 1 for respective strong and poor similarity, we added negativity in the log function.

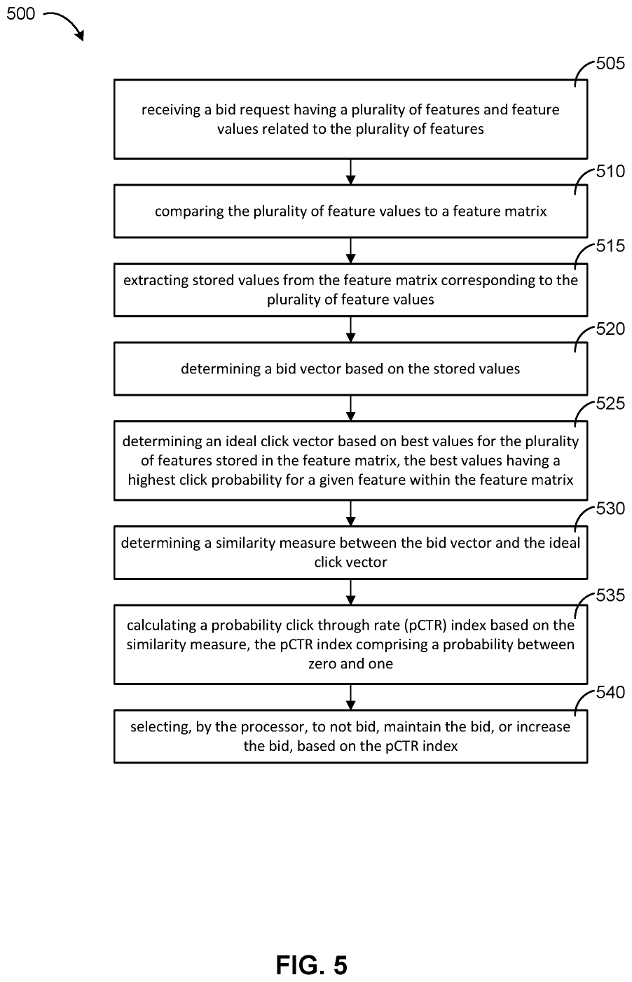

FIG. 5 is a flowchart of an embodiment of a method for evaluating feature selection in an advertisement campaign according to the disclosure.

At block 505, the processor can receive a bid request having a plurality of features and feature values related to the plurality of features.

At block 510, the processor can compare the plurality of feature values to a feature matrix stored in a memory coupled to the one or more processors.

At block 515, the processor can extract stored values from the feature matrix corresponding to the plurality of feature values.

At block 520, the processor can determine a bid vector based on the stored values.

At block 525, the processor can determine an ideal click vector based on best values for the plurality of features stored in the feature matrix, the best values having a highest click probability for a given feature within the feature matrix.

At block 530, the processor can determine a similarity measure between the bid vector and the ideal click vector.

At block 535, the processor can determine calculate a probability click through rate (pCTR) index based on the similarity measure, the pCTR index comprising a probability between zero and one.

At block 540, the processor can select whether not bid, maintain the bid, or increase the bid based on the pCTR.

### Implemented Functions

$$\begin{matrix}Z = {Σ}_{k} wkfk p ( clk ) = \frac{1}{1 + {e}^{- Z}} \{ \begin{matrix}k = Number of active features \\ w = trained weight\end{matrix} & ( 1 ) \\ X ( ad , Z ) = {Σ}_{i} {\sum }_{k = 0}^{N} Zk ( adi ) \to [ \begin{matrix}A 1 Z 1 & ⋯ & AiZ 1 \\ ⋮ & ⋱ & ⋮ \\ A 1 Zk & ⋯ & AiZk\end{matrix} ] \{ \begin{matrix}A ∈ Advertisers ; Z ∈ Features \\ k \geq 1 ; i > 0\end{matrix} & ( 2 ) \\ pCTR ( x ) = \frac{\vec{x ( m , n )} . argmax \{ \vec{X ( i , k )} \}}{‖ X ( m , n ) ‖ . ‖ argmax \{ X ( i , k ) \} ‖} \{ \begin{matrix}m ∈ A ; n ∈ F \\ bid ( x ) = bid 2 vec \\ clk ( x ) = ideal click vector\end{matrix} & ( 3 ) \\ bid ( X ) = - {log}_{10} [ pCTR ( x ) ] & ( 4 )\end{matrix}$$

### Other Aspects

The accompanying claims and their equivalents are intended to cover such forms or modifications as would fall within the scope of the disclosure. The various components illustrated in the figures may be implemented as, for example, but not limited to, software and/or firmware on a processor or dedicated hardware. Also, the features and attributes of the specific example embodiments disclosed above may be combined in different ways to form additional embodiments, all of which fall within the scope of the disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, and algorithm operations described in connection with the embodiments disclosed herein may be implemented as electronic hardware, computer software, or combinations of both. To clearly illustrate this interchangeability of hardware and software, various illustrative components, blocks, modules, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, and modules described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects.

Thus, the claims are not intended to be limited to the aspects shown herein but is to be accorded the full scope consistent with the language claims, wherein reference to an element in the singular is not intended to mean “one and only one” unless specifically so stated, but rather “one or more.”

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for pricing an auction for an advertisement campaign in and real-time bidding environment, the method comprising:
receiving, at one or more processors, a bid request having a plurality of features and feature values related to the plurality of features;
comparing, at one or more processors, the plurality of feature values to a feature matrix stored in a memory coupled to the one or more processors;
extracting, at one or more processors, stored values from the feature matrix corresponding to the plurality of feature values;
determining, at one or more processors, a bid vector based on the stored values;
determining, at one or more processors, an ideal click vector based on best values for the plurality of features stored in the feature matrix, the best values having a highest click probability for a given feature within the feature matrix;
determining, by the one or more processors, a similarity measure between the bid vector and the ideal click vector;
calculating, by the one or more processors, a probability click through rate (pCTR) index based on the similarity measure, the pCTR index comprising a probability between zero and one; and
selecting, at one or more processors, based on the pCTR index, to
not bid,
maintain the bid, or
increase the bid.

2. The method of claim 1, wherein,
the selecting to not bid is based on a first range of probability,
the selecting to maintain the bid is based on a first range of probability different than the first range, and
the selecting to increase the bid is based on a first range of probability different than the first range and the second range.

3. The method of claim 1, further comprising
performing a test on a control line;
performing the test on a pCTR line; and
measuring key performance indicators (KPIs) of the control line and the pCTR line based on the test of the control line and the pCTR line;
selecting one of the control line and the pCTR line for use in a campaign based on the KPIs.

4. A system for pricing an auction for an advertisement campaign in and real-time bidding environment, the system comprising:
a memory for storing a feature matrix having a plurality of features and feature values associated with each feature of the plurality of features; and
one or more processors communicatively coupled with the memory and configured to
receive a bid request having a plurality of features and feature values related to the plurality of features;
compare the plurality of feature values to a feature matrix stored in the memory;
extract values from the feature matrix stored in the memory corresponding to the plurality of feature values;
determine a bid vector based on the stored values;
determine an ideal click vector based on best values for the plurality of features stored in the feature matrix, the best values having a highest click probability for a given feature within the feature matrix;
determine a similarity measure between the bid vector and the ideal click vector;
calculate a probability click through rate (pCTR) index based on the similarity measure, the pCTR index comprising a probability between zero and one; and
select whether to not bid, to maintain the bid, or to increase the bid, based on the pCTR index.

5. The system of claim 4, wherein,
the selecting to not bid is based on a first range of probability,
the selecting to maintain the bid is based on a first range of probability different than the first range, and
the selecting to increase the bid is based on a first range of probability different than the first range and the second range.

6. The system of claim 4, wherein the one or more processors is further configured to:
perform a test on a control line; and
perform the test on a pCTR line; and
measure key performance indicators (KPIs) of the control line and the pCTR line based on the test of the control line and the pCTR line;
select one of the control line and the pCTR line for use in a campaign based on the KPIs.
